(19) United States
(12) Patent Application Publication
(10) Pub. No.: US 2001/0001858 A1
(43) Pub. Date: May 24, 2001

(54) Information processing apparatus and recording medium

(76) Inventor: Toshiharu Kido, Inagi (JP)

Correspondence Address: STAAS & HALSEY LLP, 700 11TH STREET, NW, SUITE 500, WASHINGTON, DC, 20001, US

(21) Appl. No.: 09/755,029

(22) Filed: Jan. 8, 2001

Related U.S. Application Data
(63) Continuation of application No. PCT/JP99/01572, filed on Mar. 26, 1999.

(30) Foreign Application Priority Data
Jul. 10, 1998 (JP) 10-196013

(51) Int. Cl. G06F 15/00

(52) U.S. Cl. 707/512

(57) ABSTRACT

The present invention relates to an information processing apparatus that can produce contents including comments, and also to a recording medium. The present invention aims to provide an information processing apparatus and a recording medium that can easily produce and edit comments for the contents. According to the present invention, the corresponding data of each object contains a comment address. By selecting an object, the comment data corresponding to the comment address can be acquired, and the acquired comment data can be rewritten or edited.

### TECHNICAL FIELD

The present invention generally relates to information processing apparatuses and recording media, and, more particularly, to an information processing apparatus that produces contents including comments, and a recording medium used with such an information processing apparatus.

### BACKGROUND ART

Conventionally, when contents are to be produced and distributed to many specified or unspecified persons, explanations for the contents are made by using a help file that is independent of the contents, changing the shape of a balloon-like comment region incorporated into a displayed image, or explaining directly within the contents.

In such a case, other than the production of contents, other documents may be required for explaining with comments, or a function of displaying comments incorporated in advance may need to be included in the contents.

In view of this, when making explanations for contents, it is necessary to add a function of displaying comments to the produced contents. Here, the comments need to be allocated during the production of the contents. As a result, there have been problems that the allocated comments cannot easily be read or modified after the formation or execution of the contents. Therefore, the present invention is to provide an information processing apparatus and a recording medium that can perform writing and editing of comments in contents.

### DISCLOSURE THE INVENTION

In an information processing apparatus of the present invention that displays a comment region corresponding to an object region, the comment region is managed in an editable state. Also, managed comments are made readable.

The comment region corresponding to the object region displayed on a screen is detected and then made readable. In the present invention, the entire comment region that is managed is made readable.

Also, in the present invention, the comment region is displayed, the object region corresponding to the comment region is blinked and displayed.

In the present invention, the object region and the corresponding comment region may be connected by a line.

Furthermore, in the present invention, the comment region corresponding to the object region may be displayed in a balloon-like form extending from the object region.

In the present invention, the comment region corresponding to the object region may be displayed by designating the object region.

Further, in the present invention, a comment to be inputted into the comment region is stored with the object region, and the stored comment is displayed with the object region in the comment region.

In the present invention, the comment region can be freely edited by an operator, and the information required by the operator can be produced or edited as a comment.

Also, managed comments are made readable so that the comments produced or edited by an operator can be easily grasped.

Furthermore, since an operator can read comments he/she has produced or edited, the comments can be easily checked.

Since an operator can read the comment region corresponding to the object region displayed on the screen, the operator can check the comments as to the object region currently displayed on the screen.

Furthermore, since an operator can read the entire comment region that is managed, the operator can check all comments that have been produced or edited.

Also, the object region blinks so that an operator can easily recognize the object region corresponding to the currently displayed comment region.

Further, the object region and the corresponding comment region may be connected by a line on the display, so that an operator can easily recognizes the object region corresponding to the currently displayed comment region.

Also, the comment region may be displayed in a balloon-like form extending from the object region, so that the operator can easily recognize the object region corresponding to the currently displayed comment region.

### BRIEF DESCRIPTION OF THE DRAWINGS

FIG. 1 is a block diagram of an information processing apparatus of one embodiment of the present invention;

FIG. 2 is a flowchart of an operation by an application program in one embodiment of the present invention;

FIG. 3 is a flowchart of a comment input operation in one embodiment of the present invention;

FIG. 4 shows a displayed image in one embodiment of the present invention;

FIG. 5 shows the structure of data for obtaining a comment corresponding to each object in one embodiment of the present invention;

FIG. 6 is a flowchart of an operation at the time of displaying a comment in one embodiment of the present invention;

FIG. 7 shows a screen at the time of displaying a comment in one embodiment of the present invention;

FIG. 8 shows a first modification of the screen at the time of displaying a comment;

FIG. 9 shows a second modification of the screen at the time of displaying a comment;

FIG. 10 is a flowchart of a operation at the time of displaying a list of all comments in one embodiment of the present invention;

FIG. 11 shows a comment list in one embodiment of the present invention; and

FIG. 12 is a flowchart of an operation at the time of displaying a list of comments in a displayed page in one embodiment of the present invention.

### PREFERRED EMBODIMENTS FOR CARRYING OUT THE INVENTION

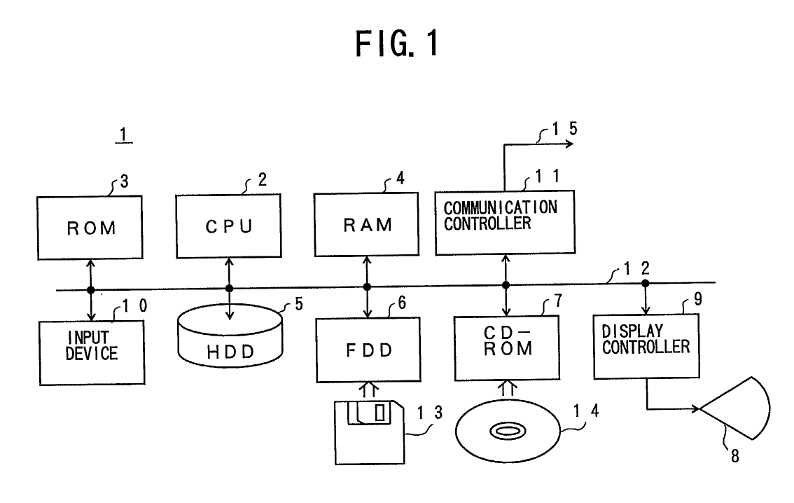

FIG. 1 is a block diagram of one embodiment of the present invention.

An information processing apparatus 1 of this embodiment comprises a CPU 1, a ROM 3, a RAM 4, a hard disk drive 5, a floppy disk drive 6, a CD-ROM drive 7, a display 8, a display controller 9, an input device 10, a communication controller 11, and a bus 12.

The CPU 2 performs desired data processing in accordance with a program that is being executed. The ROM 3 stores an activation program and an initial value. Upon activation of the information processing apparatus 1, the activation program and the initial value are read out from the ROM 3. The RAM 4 stores an application program and data supplied from the hard disk drive 5, and is used as a work area of the CPU 2.

The hard disk drive 5 stores the operation system (OS), an application program, and data. The OS, the application program, and the data are expanded by the RAM 4, and processed by the CPU 2.

A floppy disk 13 is mounted in the floppy disk drive 6. The floppy disk drive 6 records a program and data onto the floppy disk 13, and reads out a program and data already stored in the floppy disk 13.

A CD-ROM 14 is mounted in the CD-ROM drive 7, and reads out a program and data recorded on the CD-ROM 14.

The display 8 displays an image corresponding to display data. The display controller 9 is connected between the display 8 and the bus 12, and converts the display data into an image signal for displaying an image on the display 8.

The input device 10 comprises a keyboard and a mouse, and inputs an instruction and data. The communication controller 11 is connected to a communication line 15, and transmits a program or data through the communication line 15. The bus 12 is connected to the CPU 2, the ROM 3, the RAM 4, the hard disk drive 5, the floppy disk drive 6, the CD-ROM drive 7, the display 8, the display controller 9, the input device 10, and the communication controller 11, thereby transmitting and receiving commands and data.

Presentation software is installed as an application program in the hard disk drive 5 of this embodiment.

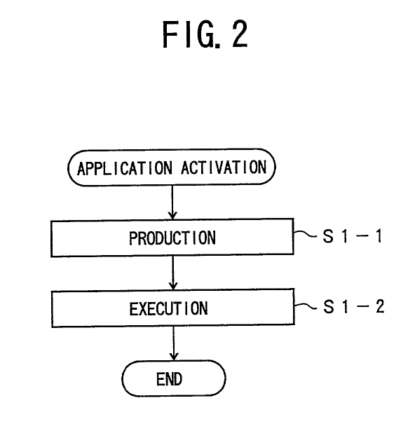

FIG. 2 is a flowchart of the application program of one embodiment of the present invention.

The application program of this embodiment is activated by handling the input device 10. The application program of this embodiment comprises a production process (step S1-1) and an execution process (step S2-1).

In the production process of step S1-1, contents for multimedia titles and presentation are produced.

In the execution process of step S1-2, display is carried out in accordance with the contents produced in S1-1, thereby executing the contents.

Comments are inputted when the contents are produced in step S1-1 and when the contents are executed in step S1-2.

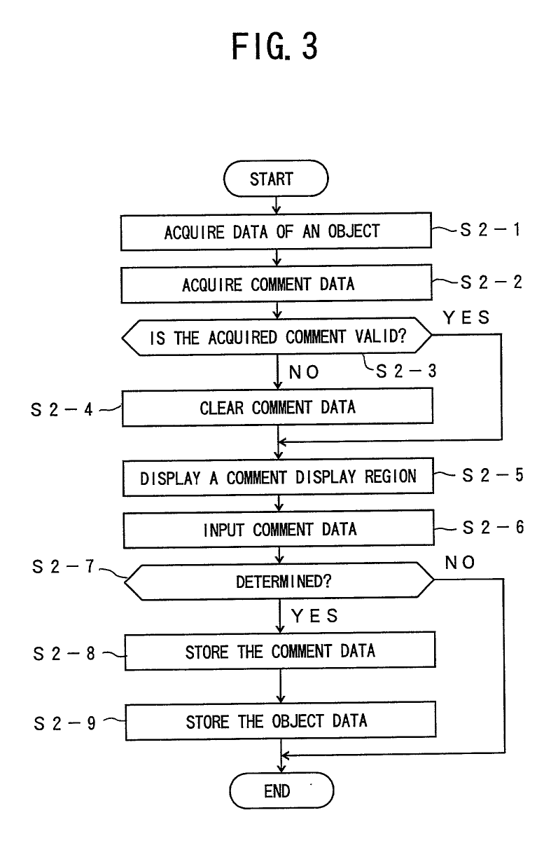

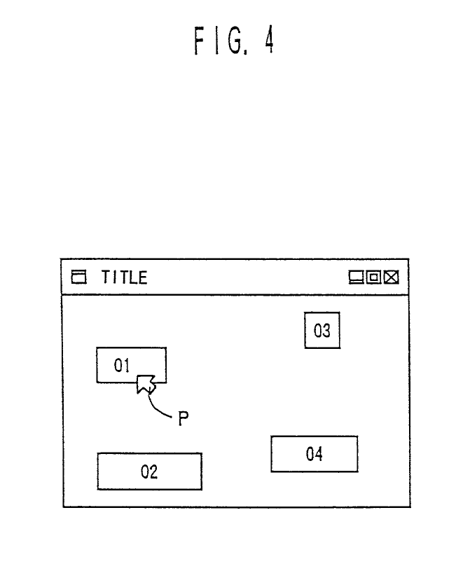

FIG. 3 is an operation flowchart of the comment input process of one embodiment of the present invention. FIG. 4 illustrates the comment input process.

Using the input device 10, a predetermined operation is first performed. For instance, a pointer set on a screen is moved by a mouse to the location of a comment input process button set by a tool bar (not shown) in a selected application program, and the comment input process is started.

In the comment input process, the mouse of the input device 10 is handled so as to position a pointer P to an object O1 into which a comment is to be inputted, as shown in FIG. 4. By doing so, the data allocated to the object O1 is obtained in step S2-1.

It should be noted that identification numbers ID1 to ID4 are respectively allocated to the objects O1 to On set in the application program.

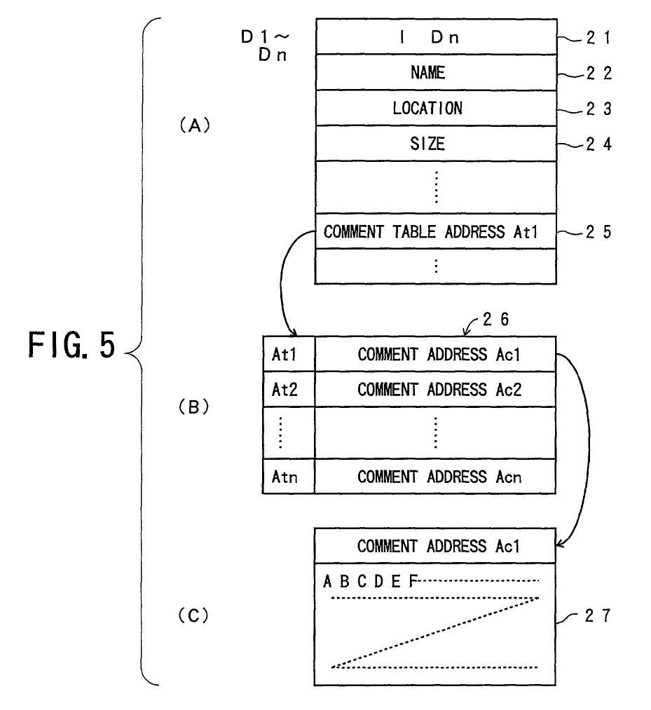

FIG. 5 shows the structure of data allocated to objects in one embodiment of the present invention. FIG. 5A shows data D1 to Dn allocated to the objects O1 to On. FIG. 5B is a comment address table that collectively manages addresses at which comments are stored. FIG. 5C shows comment data.

The data D1 to Dn allocated to the objects O1 to On set in the application program of this embodiment, contains identification information 21, name information 22, position information, size information, comment table address information 25, and other information, as shown in FIG. 5A. The identification information 21 comprises identification numbers ID1 to IDn for identifying the objets O1 to On. The name information 22 comprises names allocated to the objects O1 to On. The position information 23 represents the location of each of the objects O1 to On on the screen. The size information 24 represents the size of each of the objects O1 to On. The comment table address information 25 represents corresponding addresses At1 to Atn on a comment table 26.

The comment table 26 holds addresses Ac1 to Acn at which comments corresponding to the comment table addresses At1 to Atn are stored.

At each of the addresses Ac1 to Acn held on the comment table 26, a corresponding comment 27 shown in FIG. 5C is stored.

In step S2-1, by pointing out a desired one of the objects O1 to On with the pointer P, the data D1 to Dn corresponding to the objects O1 to On can be obtained, as shown in FIG. 5A

After step S2-1, comment data is acquired from the comment table address information 25 of the acquired corresponding data D1 to Dn in step S2-2. In step S2-2, the comment table address At1 is acquired from the comment table address information 25 of the acquired corresponding data D1 to Dn. Next, in accordance with the acquired comment table addresses At1 to Atn, the comment table 26 is searched for the comment addresses Ac1 to Acn corresponding to the acquired comment table addresses At1 to Atn. After the acquirement of the comment addresses Ac1 to Acn from the comment table 26, the acquired comment addresses are accessed, and the corresponding comment data are acquired.

After the acquirement of the comment data in step S2-2, it is determined whether or not the acquired comment data is valid in step S2-3.

In step S2-3, if text data is set as valid data, the data at an accessed address is determined whether or not to be text data. If the data at the accessed address is text data, it is determined to be valid. If the data at the accessed address is in some other data format, such as image data or audio data, it is determined to be invalid.

If the data at the accessed address is determined to be valid in step S2-3, the comment data at the accessed address is displayed, in step S2-5, in a comment display region in a format that will be described later.

If the data at the accessed address is determined to be invalid in step S2-3, the data at the accessed address is cleared in step S2-4, and the comment display region is then displayed, in step S2-5, in the format that will be described later.

In this case, an operator writes or edits a comment in the comment display region with the input device 10 in step S2-6. After the writing or editing of the comment, the operator operates a deterministic button provided on a tool bar, and the comment is determined in step S2-7. After the determination of the comment, the comment data inputted in step S2-6 is stored in the comment display region in step S2-8.

The address at which the comment data written in step S2-8 is set in the comment address table 26, and the comment table addresses At1 to Atn stored in the comment table 26 are stored in the comment table address information 25 of the corresponding data D1 to Dn of the objects O1 to On in step S2-9.

Next, an operation at the time of displaying an object will be described.

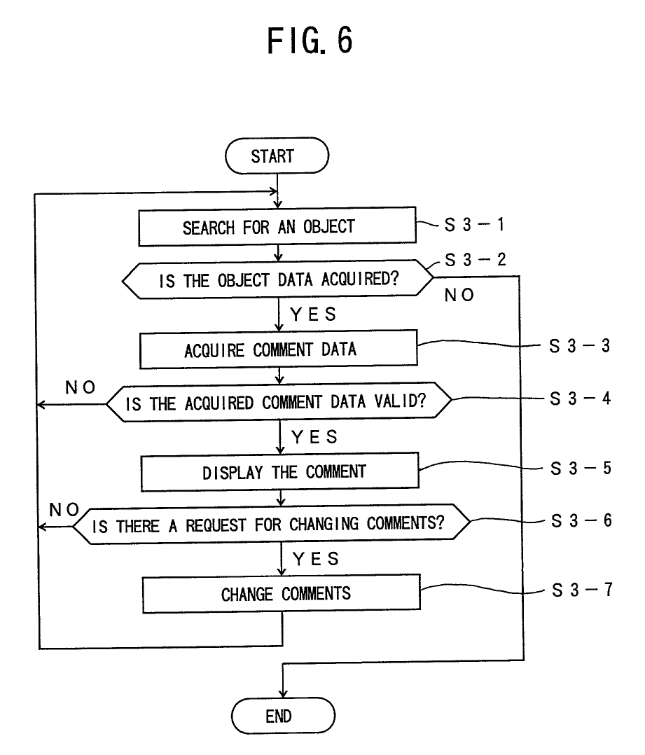

FIG. 6 is a flowchart of an operation of displaying a comment in accordance with the present invention.

When an image is displayed, the corresponding data Dm of the object Om pointed out by the pointer P is searched for in step S3-1.

After the search for the corresponding data Dm, the corresponding data Dm is acquired in step S3-2. In accordance with the corresponding data Dm of the acquired object Om, comment data is acquired in step S3-3.

In step S3-3, the comment table address information 25 is referred. The comment address Acm stored at the comment table address Atm stored in the comment table address information in the comment table 26 is then referred.

The data at the address corresponding to the comment address Acm acquired from the comment table 26 is acquired as comment data.

After the acquirement of the comment data in step S3-3, it is determined whether or not the acquired comment data is valid in step S3-4.

In step 3-4, if text data is set as valid data, for instance, it is determined whether or not the data at an accessed address is text data. If the data at the accessed address is text data, it is determined to be valid. If the data at the accessed address is in some other format, such as image data or audio data, it is determined to be invalid.

If the data at the accessed address is determined to be valid in step S3-4, the comment data at the accessed address is displayed in a comment display region in a format that will be described later in step S3-5.

In the following, the comment display region will be described.

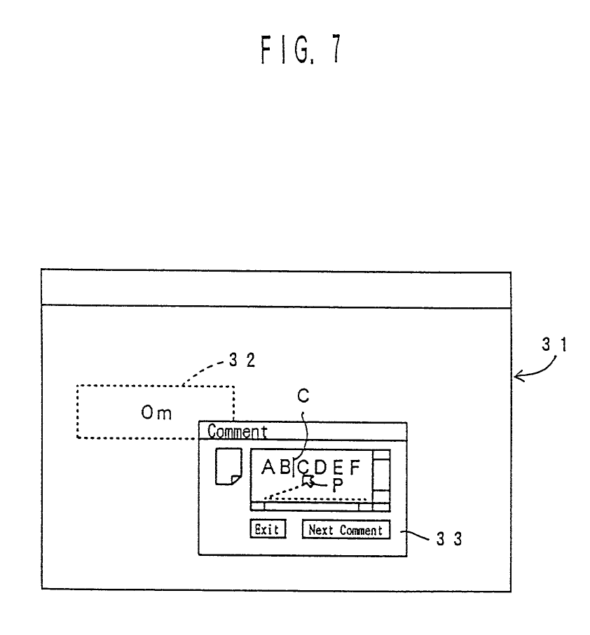

FIG. 7 shows a screen at the time of displaying a comment in accordance with the present invention.

On a screen 31 at the time of displaying a comment, a comment display region 33 is displayed in the vicinity of the object Om. Here, the outer frame 32 of the object Om blinks, so that the object Om corresponding to the contents of a comment in the displayed comment display region 33 can be easily recognized.

In FIG. 7, the object Om blinks to notify the correspondence between the object Om and the contents of the comment display region 33. However, it is not limited to this example.

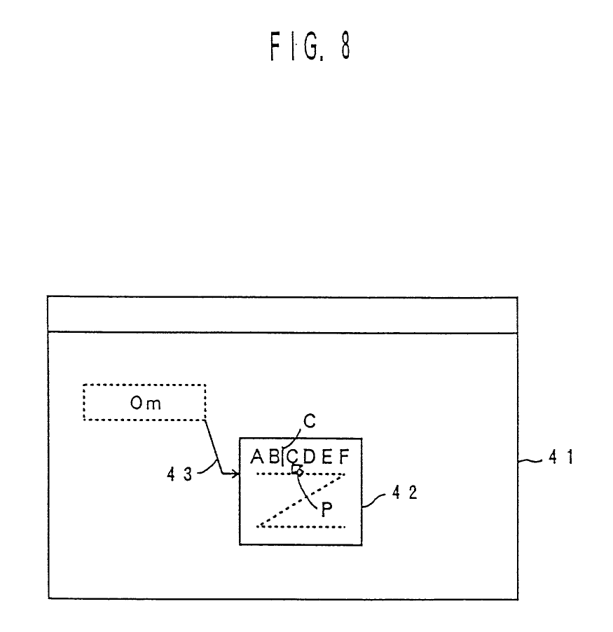

FIG. 8 shows a first modification of a screen at the time of displaying a comment in accordance with the present invention.

In a screen 41 at the time of displaying a comment, a corresponding comment display region 42 is displayed in the vicinity of the object Om. Here, the object Om and the corresponding comment display region 42 are connected by a line 43, so that the correspondence between the object Om and the comment display region 42 can be readily recognized. In this modification, the line 43 that connects object Om and the corresponding comment display region 42 is bent. However, it is of course possible to employ a straight line or a curved line.

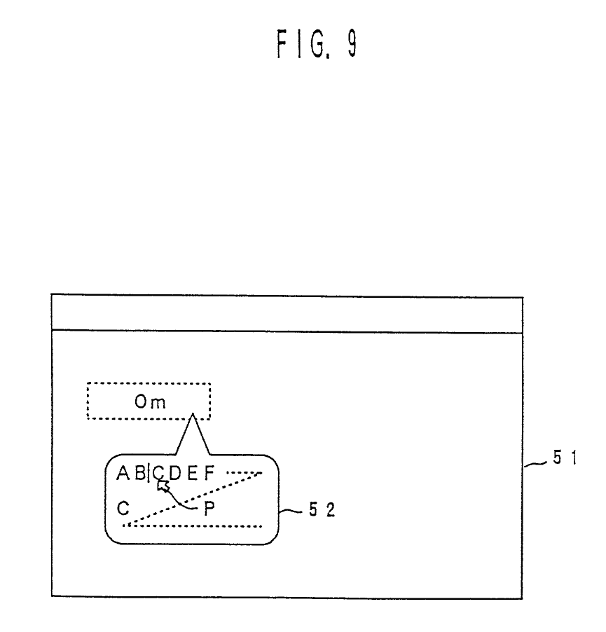

FIG. 9 shows a second modification of the screen at the time of displaying a comment in accordance with the present invention.

In a screen 51 at the time of displaying a comment, a corresponding comment display region 52 is displayed in the vicinity of the object Om. Here, the comment display region 52 is in the form of a “balloon” that is blown from the object Om, so that the correspondence between the object Om and the comment display region 52 can be readily recognized.

By the application program of this embodiment, a comment list is displayed so that all comments to be displayed can be easily recognized.

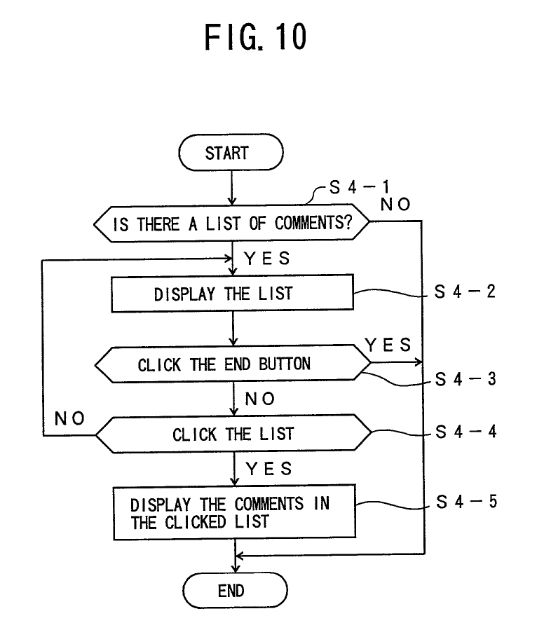

FIG. 10 is a flowchart of an operation at the time of displaying all the comments in accordance with one embodiment of the present invention.

To display all the comment, an operator selects a comment list display button on the tool bar with the input device 10. Here, it is determined whether or not a comment list exists in step S4-1.

If a comment list exists in step S4-1, all the comments are displayed in the form of a list in step S4-2.

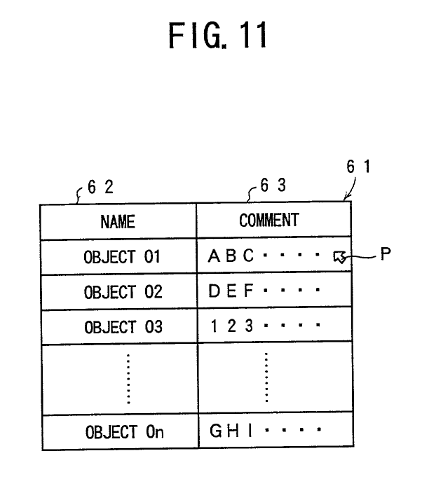

FIG. 11 shows an example of the comment list in accordance with the present invention.

A comment list 61 comprises a name display column 62 and a comment display column 63. The name display column 62 shows the names of all the objects O1 to On. The comment display column 63 displays the contents of comments predetermined for the objects O1 to On displayed on the name display column 62.

The comment display column 63 may display only the beginning of each comment, as shown in FIG. 11, or may display all part of each comment.

Referring back to FIG. 10, after the comment list 61 shown in FIG. 11 is displayed in step S4-2, an end button set on the tool bar is clicked in step S4-3, thereby ending the display of the comment list.

The operator handles a mouse that constitutes the input device 10, so that the pointer P is moved to the name or comment of a desired object on the comment list 61 shown in FIG. 11. The operator then clicks the left button of the mouse in step S4-4. After that, in step S4-5, the comment corresponding to a selected object O1 is then displayed in the comment display region 33, 42, or 52, as shown in FIGS. 7 to 9.

As described above, the pointer P is moved to the comment display region 33, 42, or 52, which displays the comment, by handling the mouse of the input device 10, and the left button of the mouse is double-clicked, thereby setting a cursor C on the comment displayed in the comment display region 33, 42, or 52, and enabling correcting and editing of the comment.

By displaying the list of the comments allocated to all the objects O1 to On, the comments can be easily grasped, and correcting and editing can be readily carried out by clicking a desired comment displayed on the screen.

Although the comment list of the above example includes the comment list of all the objects O1 to On, it is also possible to display only a list of comments of objects displayed on the screen.

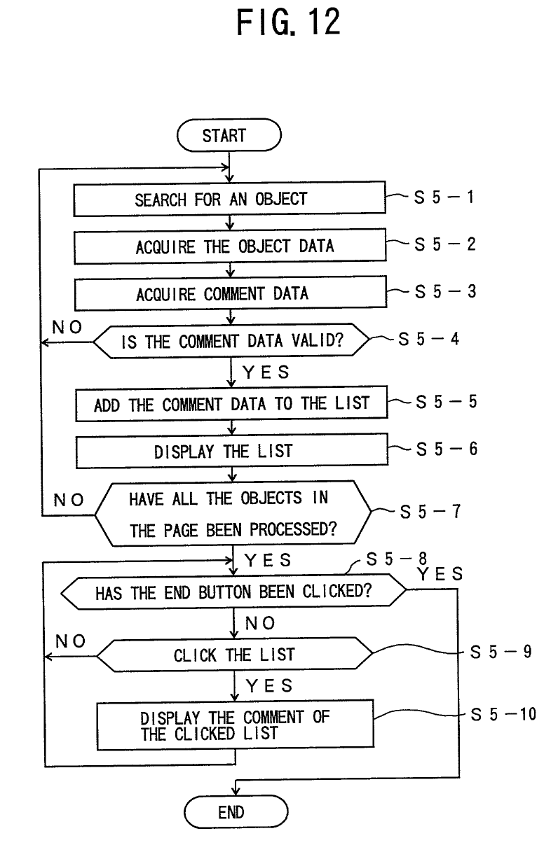

FIG. 12 is a flowchart of an operation at the time of displaying a list in a page in accordance with the present invention.

When the image shown in FIG. 4 is displayed, for instance, a page list display button on the tool bar is clicked to search for the objects O1 to O4 displayed in the displayed page in step S5-1.

After the search in step S5-1, the object O1 is first detected, for instance. In such a case, the corresponding data D1 of the detected object O1 is acquired in step S5-3.

From the comment table address information 25 in the acquired data D1 shown in FIG. 5, the comment table address At1 is acquired. Based on the acquired comment table address At1, the comment table 26 is searched to acquire the comment address Ac1 corresponding to the acquired comment table address At1. After the acquirement of the comment address Ac1 from the comment table 26, the acquired comment address Ac1 is accessed to acquire the corresponding comment data.

After the acquirement of the comment data of the object O1 in step S5-3, it is determined whether or not the acquired comment data is valid in step S5-4.

In a case where text data is set as valid data, it is determined, in step S5-4, whether or not the data at the accessed address is text data. If the data at the accessed address is text data, it is determined to be valid. If the data at the accessed address is in some other data format, such as image data or audio data, it is determined to be invalid.

If the data at the accessed address is determined to be valid in step S5-4, the name of the object O1 is read out from the corresponding data D1, and registered in the name display column 62 of the comment list 61 shown in FIG. 11. At the same time, the comment data is registered in the comment display column 63 in step S5-5.

In step S5-6, a comment list of all the objects O1 to O4 set on the screen 31 is produced and displayed, as shown in FIG. 11.

The process of steps S5-1 to S5-6 is performed for all the objects O1 to O4 set on the screen 31 in step S5-7.

After the formation and display of the comment list of the objects O1 to O4 displayed on the screen 31 in the format shown in FIG. 11 in step S5-7, the end button set on the tool bar is clicked in step S5-8, thereby ending the display of the comment list.

Meanwhile, an operator handles the mouse that constitutes the input device 10 so as to move the pointer P to the name or comment of a desired object on the comment list 61 shown in FIG. 11. The operator then clicks the left button of the mouse in step S5-9, thereby displaying the comment corresponding to a selected object O1 in the comment display region 33, 42, or 52 shown in FIGS. 7 to 9 in step S5-10.

In step S5-10, the pointer P is moved to the comment display region 33, 42, or 52 by handling the mouse of the input device 10. By doing so, the cursor C is set on the comment in the comment display region 33, 42, or 52, thereby enabling correcting and editing the comment.

As described above, by displaying the list containing only the comments allocated to the objects O1 to O4 displayed on the desired screen 31, the comments corresponding to the objects O1 to O4 displayed on the screen 31 can be easily grasped. Also, the comment of a required object among the objects O1 to O4 is clicked, thereby easily enabling correcting and editing of the comment.

According to this embodiment, the creator of contents can display and read comments that include how to use the contents or hints. Those comments are pasted to the contents. The pasted comments can be freely corrected by an operator.

In a case where a person produces a slide sheet for an OHP (overhead projector), for instance, and another person uses the slide sheet, multimedia data incorporated into the OHP or instructions stored in the OHP can be displayed as comments for the contents. Accordingly, there is no need to produce independent documents that contain how to use the contents, for instance. Also, it is easy to grasp the correspondence between the contents and comments for easier use.

Furthermore, a user can easily write or edit comments. Thus, individual comments can be produced, and the contents can be freely handled by each user.

1. An information processing apparatus that displays a comment region corresponding to an object region, said information processing apparatus characterized by comprising a management unit that manages the comment region in an editable state.

2. The information processing apparatus as claimed in claim 1, characterized in that the management unit includes a read unit that reads comments being managed.

3. The information processing apparatus as claimed in claim 2, characterized in that the read unit comprises a first read unit that detects the comment region corresponding to the object region displayed on a screen display, and then enables reading of the detected comment region.

4. The information processing apparatus as claimed in claim 2, characterized in that the read unit comprises a second read unit that enables reading of the entire comment region managed by the management unit.

5. The information processing apparatus as claimed in claim 3, characterized in that the read unit comprises a second read unit that enables reading of the entire comment region managed by the management unit.

6. The information processing apparatus as claimed in claim 1, characterized by further comprising a display control unit that blinks the object region corresponding to the comment region when the comment region is displayed.

7. The information processing apparatus as claimed in claim 1, characterized by further comprising a second display control unit that displays a line connecting the object region and the corresponding comment region.

8. The information processing apparatus as claimed in claim 1, characterized by further comprising a third display control unit that displays the corresponding comment region in a balloon-shaped form extending from the object region.

9. The information processing apparatus as claimed in claim 1, characterized by further comprising a fourth display control unit that designates the object region, thereby displaying the comment region corresponding to the object region.

10. The information processing apparatus as claimed in claim 1, characterized in that:
the management unit comprises a storage unit that stores a comment to be inputted into the comment region, the object region, and correspondence between the comment and the object region; and
the comment stored in the storage unit is displayed with the object region in the comment region.

11. A computer-readable recording medium that stores a program for displaying a comment region corresponding to an object region, said recording medium characterized by storing a program that specifies a procedure for managing the comment region in an editable state.

12. The computer-readable recording medium as claimed in claim 11, characterized in that the managing procedure includes a process for reading comments being managed.

13. The computer-readable recording medium as claimed in claim 12, characterized in that the reading process includes a first reading process for detecting the comment region corresponding to the object region displayed on a screen display, thereby enabling reading of the comment region.

14. The computer-readable recording medium as claimed in claim 12, characterized in that the reading process includes a second reading process for enabling reading of the entire comment region managed by the managing process.

15. The computer-readable recording medium as claimed in claim 13, characterized in that the reading process includes a second reading process for enabling reading of the entire comment region managed by the managing process.

16. The computer-readable recording medium as claimed in claim 11, characterized by storing a program that specifies a display control procedure for displaying and blinking the object region corresponding to the comment region when the comment region is displayed.

17. The computer-readable recording medium as claimed in claim 11, characterized by storing a program that specifies a second display control procedure for displaying a line connecting the object region and the corresponding comment region when the comment region is displayed.

18. The computer-readable recording medium as claimed in claim 11, characterized by storing a program that specifies a third display control procedure for displaying the comment region corresponding to the object region in a balloon-like form extending from the object region.
